(19) United States
(12) Patent Application Publication
(10) Pub. No.: US 2012/0304178 A1
(43) Pub. Date: Nov. 29, 2012

(54) CONCURRENT REDUCTION OPTIMIZATIONS FOR THIEVING SCHEDULERS

(75) Inventors: David P. Grove, Ridgefield, CT (US); Igor Peshansky, Hillsdale, NJ (US); Vijay Saraswat, Mahopac, NY (US); Olivier Tardieu, White Plains, NY (US)

(73) Assignee: INTERNATIONAL BUSINESS MACHINES CORPORATION, Armonk, NY (US)

(21) Appl. No.: 13/114,593

(22) Filed: May 24, 2011

(51) Int. Cl. G06F 9/46; G06F 9/52

(52) U.S. Cl. 718/102

(57) ABSTRACT

Concurrent reduction optimizations for thieving schedulers may include a thieving worker thread operable take a task from a first worker thread's task dequeue, the thieving worker thread and the first worker thread having same synchronization point in a program at which the thieving worker thread and the first worker thread can resume their operations. The thieving worker thread may be further operable to create a local copy of memory locations associated with the task in local memory of the thieving worker thread, and store result of the thieving worker executing the task as the local copy. The thieving worker thread may be further operable to atomically perform a reduction operation to a master location that both the thieving worker thread and the first worker thread can access, in response to the thieving worker thread completing the task.

### STATEMENT REGARDING FEDERALLY SPONSORED RESEARCH OR DEVELOPMENT

This invention was made with Government support under Contract No. HR0011-07-9-0002 awarded by (DARPA) Defense Advanced Research Projects Agency. The Government has certain rights in this invention.

### FIELD

The present application generally relates to computer systems and parallel processing, and more particularly to concurrent reduction optimizations for thieving schedulers.

### BACKGROUND

Parallel programming paradigm performs reduction operations by having multiple processing elements each operate on part of data and then combining the results of the multiple processing elements at one processing element. In the current programming environments such as the Cloud infrastructure which include a tremendous number of tasks running concurrently, this means processing thousands of messages at one processing element to perform a reduction operation.

For instance, consider the following illustrative example of concurrent reduction Fib. Start with the simple recursive definition of Fibonacci, Program 0:

public class Fib {

static def fib(n:Int )

= (n <=2) ? 1 : fib(n−1) + fib(n−2);

}

We wish to evaluate fib in parallel. This is a simple example illustrating a basic idiom in several recursive programs that can take advantage of parallel evaluation. A straightforward way of doing this would be Program 1:

public class Fib {

static def fib (n : Int )

= (n <=2) ? 1 : async fib (n−1) + fib (n−2);

}

Here we intend the semantics that permits the arguments to a method or an operator to be evaluated in parallel if they are marked with an async; all argument evaluations must finish before the method or operator is invoked. In more detail this looks like Program 2:

public class Fib{

static def fib (n : Int ) {

if (n <= 2)

return 1;
@shared var n1 : Int=0;
var n2 : Int=0;
finish {

async n1=f i b (n−1);
n2=fib (n−2);

}
return n1+n2 ;

}

}

The recursive finish statements are unnecessary. They serve merely to ensure that intermediate results have been computed so that an addition operation can be performed. However, addition is commutative and associative. Hence we can rewrite this as Program 3:

public class Fib {

static def fib (n : Int ) {

@shared var result : Int=0;
def eval (n : Int ) {

if (n <=2) {

atomic result++;
return;

}
async eval (n−1);
eval (n−2);

}
finish eval (n);
return result;

}

}

Note the use of a recursively defined function that accesses a mutable location in the environment. The annotation @ shared is used to mark a mutable local variable that can be accessed asynchronously (that is, from within the bodies of spawned asyncs). Note that Program 3 is safe: the program computes precisely the same result as its serial elision.

Note in passing that one could replace the recursively defined local function with the use of (the more expressive) nested class, Program 4:

public class Fib {

static def fib (n : Int ) {

new Object ( ) {

var result : Int=0;
def eval (n : Int ) {

i f (n <=2) {

atomic result++;
return;

}
async eva l (n−1);
eval (n−2);

}
def run( ) {

finish eval (n) ;
return result;

}

}.run ( );

}

}

However, not much has been gained; on the contrary the syntax is more verbose, and some transparency has been lost. Depending on the runtime representation for supporting fine-grained concurrency, the second alternative may be worse than the first. The implementation will have to figure out that the newly created object does not escape and that there is no need to create an object on the heap, result can be allocated on the stack. Worse, the programmer will have to reason about this to establish correctness. For, if a reference to the object escapes, then it is possible to have a second invocation of run( ) in parallel with the first, yielding incorrect behavior. Another observation is that the result location is a hot-spot: it is going to be hammered an exponential number of times by concurrently executing threads.

### BRIEF SUMMARY

A method for concurrent reduction optimization for thieving scheduler, in one aspect, may include a thieving worker thread taking a task from a first worker thread's task dequeue, the thieving worker thread and the first worker thread having same synchronization point in a program at which the thieving worker thread and the first worker thread can resume their operations. The method may also include creating a local copy of memory locations associated with the task in local memory of the thieving worker thread and storing result of the thieving worker executing the task as the local copy. The method may further include atomically performing a reduction operation to a master location that both the thieving worker thread and the first worker thread can access, in response to the thieving worker thread completing the task.

A system for concurrent reduction optimization for thieving scheduler, in one aspect, may include a processor and memory operable to store shared data among a plurality of threads executing on the processor, and local data local to each of the plurality of threads. The system may also include a thieving worker thread operable to execute on the processor, and further operable to take a task from a first worker thread's task dequeue. In one aspect, the thieving worker thread and the first worker thread have same synchronization point in a program at which the thieving worker thread and the first worker thread can resume their operations. The thieving worker thread may be further operable to create a local copy of memory locations associated with the task in local memory of the thieving worker thread, and store result of the thieving worker executing the task as the local copy. The thieving worker thread may be further operable to atomically perform a reduction operation to a master location that both the thieving worker thread and the first worker thread can access, in response to the thieving worker thread completing the task.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a block diagram illustrating multiple workers performing the concurrent reduction operation in one embodiment of the present disclosure.

FIG. 2 is a system diagram illustrating components in one embodiment of the present disclosure.

### DETAILED DESCRIPTION

A technique is disclosed, in one aspect, for specifying reduction operations on mutable locations in languages supporting fine-grained concurrency. The concurrent reduction implementation technique of the present disclosure reduces the number of updates to the “result” construct. In brief, the technique implements a set of commuting atomic updates on a shared variable with an equivalent set of updates on worker-local copies, followed by fewer atomic updates on the shared variable. In another aspect, the technique also augments thieving schedulers for such languages with support for concurrently and efficiently evaluating such reduction operations.

A reduction operation is an operation that combines the elements provided in the input buffer of each process in a group, using the specified operation, and returns the combined value in the output buffer of a designated process. Mutable locations refer to memory locations (e.g., defined by program objects or variables) whose states can be modified after they are created, for example by different threads. This is in contrast to immutable locations or objects that cannot be modified after they are created. “Const” attribute in programming language usually designates an immutable object. Fine-grained concurrency may involve threads which interleave their accesses to memory, for example, at the granularity of single instruction execution. X10 is an example language that may support fine-grained concurrency.

It is observed that access to the shared variable “result” are of two kinds:

1. There is an initial phase of concurrent accesses in atomic result++; occurring within the scope of the finish in the above example code.
2. These concurrent accesses are representable as the application of a reduction operator. A reduction operator R (over type T) is a pair (f:(T,T)=>T,z:T) satisfying the property that f is associative and commutative, and has zero z. That is, for all a,b,c, f satisfies (a,f(b,c))=f(f(a,b),c) and f(a,b)=f(b,a) and f(a,z)=a and f(z,a)=a. An application of R to a location 1 (of type T) takes an argument a:T and atomically performs 1=f(a,l). In the above example, the reduction operator is (Int.+, 0) and the (implicit) argument to the application of the reduction operator is 1.

After this phase has terminated (marked with the finish operation) the variable is accessed, and should contain the correct result of all the concurrent applications of the reduction operator. The finish construct waits for termination of parallel computation, that is, causes an activity to block (to suspend its execution) until all its sub-activities have completed. In one embodiment of the present disclosure, the programmer, compiler, or runtime environment, or combinations thereof, may be enabled to mark certain locations as “accumulator” locations that is subject to concurrent reduction. For example, in one embodiment of the present disclosure, a programmer may be permitted to mark a reduction phase on a location by adding an @reduction(op, zero, loc) annotation on a finish construct. To check that this annotation is sound, the compiler establishes that in the dynamic extent of the body of the finish statement, all operations performed on loc are applications of the reduction operator (op,zero). Specifically, we now represent our example program as follows:

public class Fib {

static def fib (n : Int ) {

@shared var result : Int=0;
def eval (n : Int) {

if (n <=2) {

atomic result++;
return;

}
async eval (n−1);
eval (n−2);

}
@reduction ( Int .+ , 0, result)
finish

eval (n);

return result;

}

}

In one aspect of the present disclosure, an implementation technique reduces the number of atomic updates performed by P processors, while preserving correctness. Briefly, an atomic operation refers to an operation in which the operations are executed in a single step while other activities are suspended. An atomic operation is not divisible, and is either performed entirely, or not performed. The technique of the present disclosure replaces N atomic applications of the reduction operator with W atomic applications (and N-W isolated, zero-overhead, applications that are guaranteed to be atomic), where W is the number of thefts performed by the P processors.

Thieving schedulers refer to class of schedulers that are characterized by the following structure. A collection of workers is executing a given task. The collection of workers may be dynamically varying. Workers may be implemented as threads executing tasks (program instructions) on a processor core. The workers may exist on the same computation node, or may be scattered across multiple nodes in a cluster, for instance, in the general case of global scheduling. A node may be an integrated circuit that includes a single or multiple processing cores. A core is an independent processing unit that can independently execute a task, and may include a logical execution unit having functional units (e.g., integer unit, floating point unit, etc.) and a cache memory (e.g., L1 cache). During execution, a worker may encounter a piece of parallel work or task, and create an entry in a local data-structure, referred to as the task dequeue. The entry may be the new task, in which case the worker continues executing with the current continuation (i.e., the current task the work was executing), or the entry may be a representation of the current continuation, in which case the worker continues by executing the new task. Each task is controlled by a data-structure called the finish record. A finish record is associated with a resumption operation. This operation can only succeed once all the tasks associated with the finish record and tasks that are spawned, if any, have terminated. When a worker runs out of work or enters a suspension associated with a resumption operation, it looks to steal a task from the task dequeue of another worker, referred to as the victim. On stealing a task it increments a counter associated with the finish-record f governing the task. When it completes the work on that task, it decrements the counter associated with f. Once this count has reached 0, a resumption operation on f can continue. The number of thefts associated with a task is the number of steals performed by workers executing the task or its descendant tasks. Thieving schedulers try to minimize the number of steals by arranging for “fat” tasks to be stolen.

The technique of the present disclosure in one aspect integrates loosely synchronized replicated copies of a data-structure with the operation of thieving schedulers, and the specification of such operations via annotations on ordering control constructs. The technique of the present disclosure, in another aspect, may permit the same variable to be used in different ways during different phases of execution. In yet another aspect, the technique of the present disclosure may support concurrent reduction operations in hardware through modifications of cache coherence protocols.

The technique of the present disclosure may be applicable in many settings, for example, including the application of Map-Reduce techniques to irregular workloads, which need dynamic load balancing.

In one embodiment of the implementation technique of the present disclosure, when a thieving worker steals a task, it creates a new worker-local copy of all locations marked as reduction locations at the finish associated with the task being stolen. (A programmer may be permitted to mark a reduction phase on a location, for example, by adding @reduction(op, zero, loc) annotation on a finish construct). Locations refer to memory store where data associated with a task is stored for a processor to operate on, for example, register locations, cache memory locations, and others. A worker that steals a task creates its local copy of the data associated with the task, i.e., storage local to the thread. These shadow locations are initialized with the zero of the associated reduction operator.

Let l be one such reduction local. During the task execution, a worker performs all reduction operations on l on its local copy lw. Since only the worker has access to lw, the operation can be performed without incurring any overhead to ensure atomicity.

When the worker “quiesces” (i.e., when all activities have been performed) on this task, it atomically performs the operation fn (lw) on l, where fn is the function associated with the reduction operator. This operation is performed atomically since other workers may be attempting to perform the same operation simultaneously. This is done before the finish record associated with the task is updated. For efficiency, it is permissible for the worker to periodically update the master location with the contents of this shadow location by performing an atomic reduction operator. The worker may need to do this, for instance, to reclaim the space being used for the shadow copy, for example, the cache line containing the shadow location is about to be flushed.

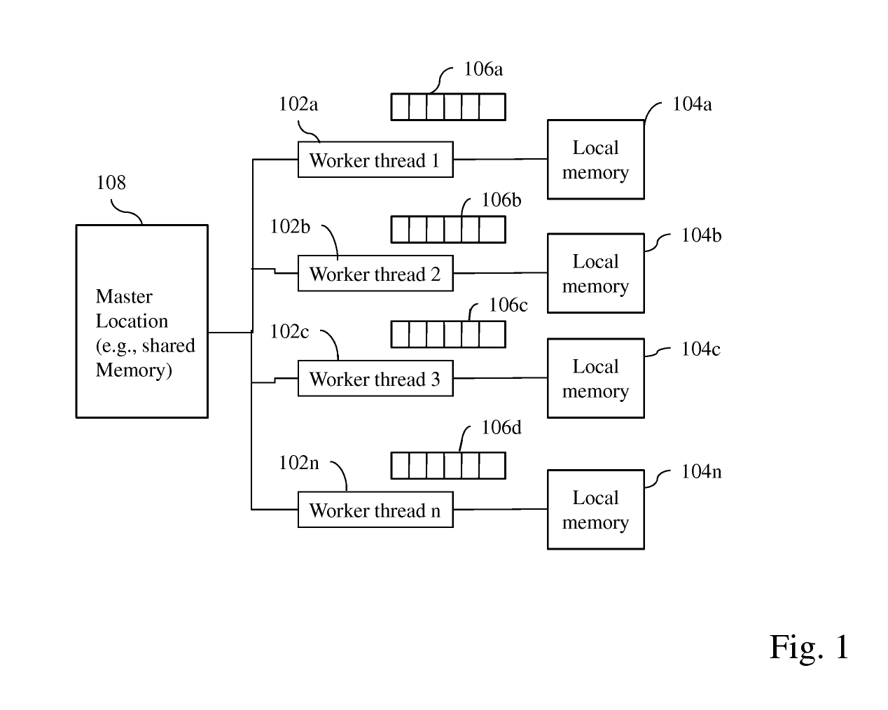

FIG. 1 is a block diagram illustrating multiple workers performing the concurrent reduction operation in one embodiment of the present disclosure. Each of the workers (threads) (102a . . . 102n) running on one or more processor cores allocates a local memory (104a . . . 104n) for placing the results of its work. The results are also reduced in the local memory. Each worker (102a . . . 102n) may have a queue of tasks (referred to as task dequeue) 106a . . . 106n. As an example, if worker thread 1 (102a) is completed with all the tasks in its queue (106a), worker thread 1 (102a) may take a task from another work thread's task dequeue, for example, from worker thread 2 (102b)'s task dequeue 106b, updating a finish record associated with the task that it is stealing. Worker thread 1 (102a) creates a new worker-local copy of all locations determined as reduction locations in its local memory 104a. Reduction locations may be determined, in one embodiment, by detecting marked locations at the finish associated with the task being stolen. These shadow locations are initialized with the zero of the associated reduction operator. During task execution, worker thread 1 (102a) performs all reduction operations on its local copy. Since only worker thread 1 (102a) has access to its local copy, the operations can be performed without incurring any overhead to ensure atomicity, i.e., without being concerned about other worker threads writing to the same location. When worker thread 1 (102a) completes the task that it stole, worker thread 1 (102a) performs the reduction operation on the location (master location) 108 specified in the reduction operation. Worker thread 1 (102a) then may update the finish record associated with the stolen task.

In one embodiment of the present disclosure, it may be ensured (e.g., optionally) that until control reaches a synchronization point (e.g., the finish construct), programs may not read the contents of these memory locations (e.g., the master location), but only perform a reduction operation against its current contents.

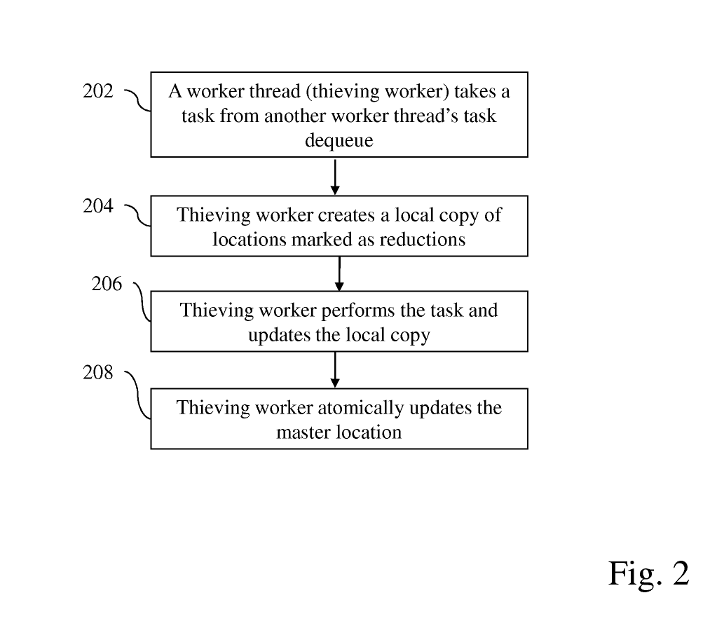

FIG. 2 is a flow diagram illustrating a method of performing the concurrent reduction operation in one embodiment of the present disclosure. At 202, a worker (referred to as a thieving worker) takes a task from another worker's task dequeue. At 204, the thieving worker creates a new worker-local copy of all locations marked as reduction locations at a finish construct associated with the task being stolen. At 206, the thieving scheduler performs its task and writes the results in the new worker-local copy. Reductions of its tasks are updated in the new worker-local copy. At 208, the thieving scheduler atomically performs the reduction operation using the data of its worker-local copy on the master location, i.e., memory location shared by the workers for storing the final reduction data. In another aspect, the thieving scheduler may periodically update the master location with the contents of its local version, during the execution of the task.

The methodology of the present disclosure may be extended to hardware by modifying cache-coherency protocols. The notion of reduction locations at the hardware level may be implemented by using extra meta-data bits with the location. When a processor P accesses such a location, a copy of the current contents of the location is brought into P's cache as usual. The zero value is written into this location without generating any cache-coherency traffic. When P performs a reduction operation on this location, it performs the operation locally on the data in its cache, without attempting to get an exclusive lock on this location or performing any cache coherency traffic. Whenever the data needs to be evicted from the cache, the corresponding reduction operation is performed on the original location. This write to the original location does not generate any cache coherency traffic, for example, to invalidate the local copies in the caches of other processors. A special local finish instruction, for example, introduced by a compiler, may ensure that such shadow reduction locations are flushed. Hardware support for cache-to-cache stealing of tasks, and manipulation of the corresponding finish records may be also provided.

X10 is a programming language being developed at International Business Machines Corporation, Armonk, N.Y., in collaboration with its partners. X10 is a distributed object-oriented language supporting parallel processing. X10 may run on low-end and high-end systems built out of multi-core chips with non-uniform memory hierarchies and interconnected in scalable cluster configurations. A cluster configuration refers to a computing configuration in which a single computer contains multiple multi-threaded processors or nodes. X10 includes, among others, “async”, “future”, “foreach”, and “ateach” constructs; constructs for termination detection (finish) and phased computation (clocks); the use of lock-free synchronization (atomic blocks); and the manipulation of global arrays and data structures.

In one aspect of the present disclosure, in programming languages such as X10, with support for fine-grained concurrency and ordering (i.e., constructs for termination or quiescence detection, such as finish, clocks, barriers), the ordering constructs may be associated with a specification of reduction locations. This permits the programmer to specify his or her design intent about how these locations are to be used during the dynamic extent of that ordering construct. It permits the compiler to check for the validity of the assertion by performing an effects analysis on the affected code.

In an implementation of such a language using thieving schedulers, such reduction locations may be implemented efficiently by keeping per-worker shadow copies on which the worker operates in lieu of operating on the master location. These copies may be reconciled with the master-location periodically, and are reconciled before the termination of the ordering construct at the worker.

Existing cache-coherence protocols can be modified to support shadow-on-read and update-on-flush semantics for reduction locations.

In another embodiment of the present disclosure, the thieving scheduler technique described above may be implemented via a pure source-to-source transformation. For example, consider the following program:

public class Fib {

static def fib (n:Int) {

@shared val results : Rail [Int]

= Rail . make [Int] (here . numWorkers( ), (Int) => 0);

def eval (n : Int) {

if (n <= 2) {

results (worker . currentWorker ( ). id) ++;
return;

}

async eval (n−1);
async (n−2);
}
finish eval (n);
val result = results . reduce (Int .+, 0);
return result;

}

}

The above solution approximates the thieving scheduler technique without requiring any implementation-level support. A new Rail is created with as many entries as the worker. For a worker with index i, the location results (i) is the thread local shadow of the original location. Once termination of the phase is detected with a finish, an explicit reduction operation is performed. This solution can be generalized to work across multiple places (global scheduling).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for concurrent reduction optimization for thieving scheduler, comprising:
a thieving worker thread taking a task from a first worker thread's task dequeue, the thieving worker thread and the first worker thread having same synchronization point in a program at which the thieving worker thread and the first worker thread can resume their operations;
creating a local copy of memory locations associated with the task in local memory of the thieving worker thread;
storing result of the thieving worker executing the task as the local copy;
atomically performing a reduction operation to a master location that both the thieving worker thread and the first worker thread can access, in response to the thieving worker thread completing the task; and
ensuring optionally that until a control reaches the synchronization point, one or more threads in the program only perform a reduction operation against current contents of the master location, but do not read the contents for other operations.

2. The method of claim 1, wherein the thieving worker periodically performs atomic reduction operation to the master location during execution of the task.

3. The method of claim 1, wherein the memory locations associated with the task are determined by detecting locations marked as reduction locations at the synchronization point.

4. The method of claim 3, wherein a programmer, a compiler, or a runtime environment, or combinations thereof, is enabled to mark the reduction locations at the synchronization point.

5. The method of claim 1, wherein the task is controlled by a finish record associated with a resume operation, and the thieving worker thread increments a count associated with the finish record when taking the task, and the thieving worker thread decrements the count associated with the finish record in response to completing the task.

6. The method of claim 5, wherein the thieving worker thread and the first worker thread resumes further operation in response to the count reaching zero.

7. The method of claim 1, wherein the thieving worker thread and the first worker thread are execution threads of a program that has concurrency operations of a programming language associated with predetermined reduction locations, and ordered constructs according to the associated predetermined reduction locations.

8. The method of claim 7, wherein the constructs include finish, clocks, barriers.

9. The method of claim 1, further including modifying existing cache-coherence protocols to support shadow-on-read and update-on-flush semantics associated with the predetermined reduction locations.

10. A system for concurrent reduction optimization for thieving scheduler, comprising:
a processor;
memory operable to store shared data among a plurality of threads executing on the processor, and local data local to each of the plurality of threads;
a thieving worker thread operable to execute on the processor, and further operable to take a task from a first worker thread's task dequeue, the thieving worker thread and the first worker thread having same synchronization point in a program at which the thieving worker thread and the first worker thread can resume their operations, the thieving worker thread further operable to create a local copy of memory locations associated with the task in local memory of the thieving worker thread, and store result of the thieving worker executing the task as the local copy, the thieving worker thread further operable to atomically perform a reduction operation to a master location that both the thieving worker thread and the first worker thread can access, in response to the thieving worker thread completing the task.

11. The system of claim 10, wherein the thieving worker periodically performs atomic reduction operation to the master location during execution of the task.

12. The system of claim 10, wherein the memory locations associated with the task are determined by detecting locations marked as reduction locations at the synchronization point.

13. The system of claim 10, wherein the task is controlled by a finish record associated with a resume operation, and the thieving worker thread increments a count associated with the finish record when taking the task, and the thieving worker thread decrements the count associated with the finish record in response to completing the task.

14. The system of claim 13, wherein the thieving worker thread and the first worker thread resumes further operation in response to the count reaching zero.

15. The system of claim 10, wherein the thieving worker thread and the first worker thread are execution threads of a program that has concurrency operations of a programming language associated with predetermined reduction locations, and ordered constructs according to the associated predetermined reduction locations.

16. The system of claim 10, further wherein existing cache-coherence protocols are modified to support shadow-on-read and update-on-flush semantics associated with the predetermined reduction locations.

17. A computer readable storage medium storing a program of instructions executable by a machine to perform a method of concurrent reduction optimizations for thieving schedulers, comprising:
a thieving worker thread taking a task from a first worker thread's task dequeue, the thieving worker thread and the first worker thread having same synchronization point in a program at which the thieving worker thread and the first worker thread can resume their operations;
creating a local copy of memory locations associated with the task in local memory of the thieving worker thread;
storing result of the thieving worker executing the task as the local copy;
atomically performing a reduction operation to a master location that both the thieving worker thread and the first worker thread can access, in response to the thieving worker thread completing the task; and
ensuring optionally that until a control reaches the synchronization point, one or more threads in the program only perform a reduction operation against current contents of the master location, but do not read the contents for other operations.

18. The computer readable storage medium of claim 17, wherein the thieving worker periodically performs atomic reduction operation to the master location during execution of the task.

19. The computer readable storage medium of claim 17, wherein the memory locations associated with the task are determined by detecting locations marked as reduction locations at the synchronization point.

20. The computer readable storage medium of claim 19, wherein a programmer, a compiler, or a runtime environment, or combinations thereof, is enabled to mark the reduction locations at the synchronization point.

21. The computer readable storage medium of claim 17, wherein the task is controlled by a finish record associated with a resume operation, and the thieving worker thread increments a count associated with the finish record when taking the task, and the thieving worker thread decrements the count associated with the finish record in response to completing the task.

22. The computer readable storage medium of claim 21, wherein the thieving worker thread and the first worker thread resumes further operation in response to the count reaching zero.

23. The computer readable storage medium of claim 17, wherein the thieving worker thread and the first worker thread are execution threads of a program that has concurrency operations of a programming language associated with predetermined reduction locations, and ordered constructs according to the associated predetermined reduction locations.

24. The computer readable storage medium of claim 17, further including modifying existing cache-coherence protocols to support shadow-on-read and update-on-flush semantics associated with the predetermined reduction locations.
